(19) United States
(12) Patent Application Publication
(10) Pub. No.: US 2004/0091664 A1
(43) Pub. Date: May 13, 2004

(54) Secondary carpet backing and carpets

(76) Inventors: Hugh C. Gardner, Roswell, GA (US); Thomas L. Baker, Winston, GA (US); Barclay B. Payne, Dalton, GA (US); Carroll M. Yawn, Powder Springs, GA (US)

Correspondence Address: CAROL WILSON, BP AMERICA INC., MAIL CODE 5 EAST, 4101 WINFIELD ROAD, WARRENVILLE, IL, 60555, US

(21) Appl. No.: 10/293,119

(22) Filed: Nov. 13, 2002

(51) Int. Cl. B32B 1/00; B32B 3/02; B32B 33/00

(52) U.S. Cl. 428/85; 428/219; 428/94; 428/95; 442/185; 139/399

(57) ABSTRACT

Secondary carpet backings woven in a flat weave construction from warp tapes and multifilament picks with to about 100% theoretical coverage in the warp but less than full effective coverage and average pick counts of 12 to 20 per inch, such that the fabrics have weights of about 1.5 to about 7 osy and air permeability, provide dimensional stability and peel strength in carpets and facilitate robust cure rates in carpet manufacture.

### FIELD OF THE INVENTION

This invention relates to carpet backings and carpets and, more particularly, carpet backing fabrics with a flat, open construction that imparts dimensional stability, delamination strength and other benefits in carpets.

### BACKGROUND OF THE INVENTION

Carpets generally comprise a primary backing structure, face yarn, a binder and in many cases a secondary backing. Face yarn penetrates the primary backing structure to form tufts projecting from one side, providing a pile surface, and stitches on an opposite side. Binder is present on the stitched side, encapsulating and adhering stitches to the backing structure to anchor the tufts. Secondary backings normally are adhered to the stitched side with the binder. Carpets typically are made by tufting face yarn through a primary backing structure with reciprocating needles that carry face yarn back and forth through the structure to form the tufts and stitches, applying a binder formulation, usually as an inert particulate-filled aqueous latex of an organic polymer, to the stitched side, and curing the binder by heating to react and polymerize the organic polymer and drive off water or other liquids and volatile curing reaction products. The secondary backing usually is laminated to the stitched side, normally by bringing it and the stitched side of the tufted structure together with binder applied to the stitched side, or to both it and the secondary backing, and curing the binder in contact with the stitched side and the secondary backing. Curing typically involves heating with hot air, as in carpet finishing ovens.

Dimensional stability of carpets has long been an area of emphasis. Carpets with inadequate stability can deform during installation and use. They also wear poorly. Lamination of secondary backings imparts added stability; however, if dimensional stability imparted by the secondary backing or delamination resistance of the bonded, tufted primary and secondary backing structure is inadequate, carpets can buckle. Delamination also can affect durability of a carpet in use. Therefore, it is important that secondary backings not only impart dimensional stability, but that they bond securely to the stitched side of tufted backing structure in finished goods.

In carpet manufacture, secondary backing features are important to these aspects of carpet performance. During curing of binders, the backing must not act as a barrier that prevents escape of volatilized liquids from the curing assembly. Carpets with incompletely cured binders or retained binder liquids tend to have less resistance to delamination than those with fully cured binders. Poorly cured binders also lose strength and integrity when wet. Moisture from surfaces on which carpets are installed or liquid spills on installed carpets can cause delamination and easier tuft loss. Even when not wet, incompletely cured binders tend to have lower tuft bind strength—that is, strength with which tufts are held in the carpet.

These considerations dictate that secondary backings be capable of imparting dimensional stability while also having high wetability by liquid binder formulations and surface area, texture and adhesive compatibility with binders for good adhesion on curing. At the same time, however, they also must have sufficient openness not to impede passage of vaporized binder liquids from the carpet during curing. Designing secondary backings to meet these requirements is complicated. Openness of backing structures conducive to good curing is unsatisfactory if it is achieved at the expense of stability-imparting properties and delamination resistance. Furthermore, influences of backing properties on dimensional stability of carpets are not well defined due to the wide range of styles, weights and other characteristics of carpets in which backings are used, as well as interactions of backings and binders within finished carpets when subjected to force. Indeed, systematic study of carpets and secondary backings showing lack of correlation between dimensional stability of carpets and backing properties suggests that the backings' ability to impart dimensional stability is best gauged from carpet performance itself.

Although many secondary backings have been proposed, including various woven, nonwoven, knitted fabrics, solid and reticulated films and composites, the secondary backing of choice for the majority of carpets that include them is a polypropylene fabric with pairs of warp tapes and spun yarn picks (also known as weft or fill yarns) woven in certain open, leno constructions in which the tapes of each of the warp pairs alternate under and over fill yarns while one of the tapes of each pair, in addition to its alternating over and under disposition, twists back and forth around the fill yarn. These fabrics, generally having about 12 to about 24 warp tapes per inch and 5 to about 15 picks per inch, with the picks having sufficient openness and texture for liquid binder penetration and adhesion of the binder when cured, impart good dimensional stability in carpets. In addition, openness of the leno weave construction is conducive to good diffusion of vaporized binder liquids during curing. Twisting of warps in the leno weave, together with wetability of the spun yarns by binder formulations, also provide a fabric surface with more crossovers and contact points among tapes and picks, greater surface texture and binder penetrability and adhesion than other weave constructions.

An example of such backings that has been widely recognized for imparting dimensional stability with good delamination strength in carpets and with openness well suited for robust curing rates during manufacture is that made and sold by Amoco Fabrics and Fibers Company under the name ActionBac® Fabric style 3870, a 2.1 ounce per square yard (“osy”) fabric with polypropylene warp tapes and polypropylene multifilament picks in a leno weave with averages of 16 warps per inch and 5 picks per inch. Average air permeability of the backings, determined according to ASTM D-737 with a pressure differential equal to 0.5 inch water, exceeds about 750 ft³/min./ft², which is ample for robust binder cure rates. Another such commercial product, ActionBac® Fabric style 3808, is similar but with a higher count, 18×13, leno weave construction. It has average air permeability above about 720 ft³/min./ft², again well suited to efficient cure rates.

In addition to leno weave secondary backing fabrics, flat fabrics with a 24×15, plain weave construction of polypropylene warp tapes and polypropylene spun fill yarns are known. Warp tapes in these backings overlap to provide about 120% theoretical coverage, which is determined by multiplying count per unit length of the tapes by tape width, dividing the product by the unit length, and multiplying the quotient by 100%. Effective warp coverage typically is somewhat lower due to irregular folding of warp tapes during weaving; average air permeability of the fabrics, however, is only about 80 ft³/min./ft², which is inadequate for high binder cure rates. Commercial sale and use of these known backings has been discontinued.

Another known flat weave secondary backing is disclosed in U.S. Pat. No. 3,542,632, which was assigned during its term to our assignee and describes backings woven from tapes in both the warp and fill and needled or abraded to fibrillate the tapes. A plain weave fabric suitable as a secondary backing is illustrated and is described as loosely woven with interstices between its yarns; however, fabrics with dimensional stability according to the patent require heat treatment to fuse fibrils of the fibrillated tapes to interlock the warp and fill. Fibrillation imparts a better surface for binder adhesion; however, it severely reduces strength and stability of the fabrics.

Seeking to overcome that difficulty while retaining improved binder adhesion due to fibrillation, U.S. Pat. No. 4,145,467 proposes secondary backings with an open, plain or other flat weave structure having unfibrillated tapes in one direction and heavily fibrillated tapes in the other. Useful secondary backings are described as having 12×9, 14×9 and 15×9 constructions of unfibrillated warps and heavily fibrillated picks. The fabrics or their fibrillated tapes are brushed, needled or brushed and needled to raise fibrils of the fibrillated tapes above the fabric surface for binder adhesion and delamination strength. Similar fabrics with 14 to 19 warp tapes per inch and 6 to 10 picks formed by fluid jet entanglement of heavily fibrillated tapes with continuous multifilament yarns are disclosed in U.S. Pat. No. 4,384,018, although its preferred secondary backings have a leno construction.

Despite those of the known backings that have found utility, as well as the many undemonstrated or abandoned concepts and structures that have been advanced, there remains a need for improved and alternative backings and carpets made therefrom, and particularly backings with stability-imparting properties, openness and binder adherability in carpets and compatibility with robust binder cure rates in their manufacture.

### SUMMARY OF THE INVENTION

This invention provides carpet backings which, despite a flat weave construction, have sufficient openness of the weave for carpet manufacture with robust cure rates, while also imparting good binder adhesion and dimensional stability in finished carpets. In addition, at least one, and in some embodiments both, surfaces of the backings have a textile-like appearance and surface character, such that the back- or floor-side of carpets with the backings have improved texture and appearance. The backings also reduce binder bleed-through during lamination, which also contributes to improved texture and appearance.

Backings according to the invention are woven from warp tapes and multifilament picks, or fill yarns, in a flat weave with a combination of high pick counts relative to many conventional secondary backings but less than full warp coverage. The backings have openness and dimensional stability- and delamination resistance-imparting properties not found in known flat weave secondary backings and without the complexity and generally lower weaving speeds used for leno weave constructions.

Surprisingly, although the flat nature of the woven backings according to the invention provides considerably less surface, texture and apparent openness than leno weave fabrics constructed from similar yarns in similar constructions, dimensional stability and delamination resistance in finished carpets prepared therefrom are comparable or superior to those of carpets made with currently preferred leno backings. In addition, the backings have sufficient openness for good binder cure rates despite their flat weave construction.

In one embodiment, the invention provides a carpet backing that imparts dimensional stability and delamination resistance in carpets. The secondary backings comprise a woven fabric having a flat weave construction with an average of about 12 to about 24 warp tapes per inch providing 50 to about 100% theoretical warp coverage but less than full effective warp coverage and with an average of about 12 to about 20 multifilament picks per inch, such that the fabric has a weight of about 1.5 to about 7 osy and average air permeability of at least about 250 ft³/min./ft.², determined according to ASTM D-737 with a pressure differential equal to 0.5 inch water.

The invention also provides carpet comprising a primary backing structure having a plurality of tufts comprising face yarn extending therefrom on a pile side and a plurality of stitches comprising face yarn disposed on a stitched side opposite the pile side, and a secondary backing laminated to the stitched side with a cured binder, wherein the secondary backing comprises a woven fabric having a flat weave construction with an average of about 12 to about 24 warp tapes per inch providing 50 to about 100% theoretical warp coverage but less than full effective warp coverage and with an average of about 12 to about 20 multifilament picks per inch, such that the fabric has a weight of about 1.5 to about 7 osy and average air permeability of at least about 250 ft³/min./ft.².

Dimensional stability-imparting properties of the invented secondary backings are at least comparable to those of leno weave secondary backings woven from like warp tapes and multifilament picks in comparable counts. In one embodiment, the invented secondary backings, when laminated in reference carpets used for comparative testing, provide carpets with retained loads, at constant strain and controlled temperature and relative humidity 16 hours after initial strain due to application of a one hundred pound load, of at least about 35 lbs. in both the warp and fill. In delamination testing according to ASTM D-3936, reference carpets with the invented backings preferably have peel strengths of at least 5.5 lbs/in.

In another embodiment, the invention provides an improved process for making a carpet comprising steps comprising tufting a primary backing structure with at least one face yarn to form a plurality of tufts on a pile side of the primary backing structure and a plurality of stitches on a stitched side opposite the pile side, contacting the stitched side and a secondary backing with a binder and curing the binder in contact with the stitched side and the secondary backing to laminate the secondary backing to the stitched side, wherein an improvement comprises using as the secondary backing a carpet backing comprising a woven fabric having a flat weave construction with an average of about 12 to about 24 warp tapes per inch providing 50 to about 100% theoretical warp coverage but less than full effective warp coverage and with an average of about 12 to about 20 multifilament picks per inch, such that the fabric has a weight of about 1.5 to about 7 osy and average air permeability of at least about 250 ft³/min./ft.². In an embodiment of the process, residence time for at least substantially complete curing of the binder is less than about 4 minutes.

### DETAILED DESCRIPTION OF THE INVENTION

Carpet backings according to the invention are woven fabrics with warp tapes and multi-filament picks, with the nature of the yarns, together with their average counts and construction in the fabrics, providing stability- and lamination strength-imparting properties for carpets and openness of the weave effective for good binder cure rates. The backings' properties are at least comparable to, and in some respects or cases better than, those of currently preferred leno weave secondary backings. These benefits are achieved despite the backings' flat weave construction, which lacks the over and under and side-to-side disposition of warps and picks that imparts the difficult combination of strength, stability and openness characteristic of leno constructions. Unlike known flat weave fabrics, the invented backings' combination of features, including warp coverage and pick counts, have not been utilized in known commercial backings, nor disclosed and recognized for their benefits and demonstrated performance in carpets.

The flat weave construction of warp tapes and multifilament picks in the invented secondary backings, as in traditional flat weave constructions of warp and weft yarns known generally in the textile arts, is characterized by warps and picks that are present in regularly alternating over and under patterns without twisting or side-to-side disposition relative to each other. Each crossover in the weave is thus formed by one warp yarn and one fill yarn. Flat weave fabrics do not include leno or other weave constructions in which the interlacing involves warp pairs disposed both over and under each fill yarn or side-to-side disposition of warps relative to the fill yarns or in which three or more yarns are present at crossovers. The invented backings also differ from leno weave fabrics most commonly used as secondary backings by their higher warp coverages. While warp coverage of leno fabrics calculated from tape widths and counts is a poor comparator because it does not account for pairing and twisting of the tapes, effective warp coverage of known leno weave secondary backings determined from openings in the weave is generally less than 40%.

Examples of weave constructions for flat fabrics suitable for the invented backings include plain weaves, twill weaves, basket weaves and satin weaves. As is known in weaving industries, plain weave constructions have a regular pattern of warp and fill yarns alternating over and under each other, with one warp passing over a pick, then under a next pick, then over a next and so on, while an adjacent warp alternates, passing under the first pick, over the next, under the next, and so on. Basket weaves are similar except that the over and under alternation of warp and fill yarns involves more than one of either or both of the warps and fill yarns. A preferred basket weave for the secondary backings of the invention is a half-basket weave with adjacent pairs of warp tapes interlaced alternately over and under, and under and over, each pick. In twill weave constructions, each fill yarn interlaces more than one warp, with the interlacing regularly offset from one to the next fill yarns such that diagonal lines are formed in the weave running in one direction on one side of the fabric and the opposite direction on the other side. Twills can be left-or right-handed, and even or uneven. Twills in which fill yarns interlace up to three warps are preferred for fabric strength. Satin weave constructions are similar to twills but with the fill yarns offset so that a visible diagonal line is not present.

Suitable flat fabrics for the invented backings are conveniently made by conventional weaving techniques, using a loom or other suitable weaving device. Projectile looms, air jet or pneumatic looms and rapier looms are examples of suitable weaving machinery.

Preferred backings according to one embodiment of the invention have approximately equal presence of warps and picks on both sides of the fabrics. Plain and basket weaves are most preferred for such fabrics, with a plain weave being most preferred due to ease of manufacture and resistance to crimping. For applications in which significantly greater presence of warp tapes on one side of the fabric and picks on the opposite side may be desired, uneven twill and satin weaves may be best suited.

Irrespective of any particular construction of the weave, warp tapes are present in the flat fabrics of the invented backings at average counts of about 10 to about 24 and provide 50 to about 100% theoretical coverage but less than full effective coverage. Fabrics constructed with theoretical coverages slightly above 100% may have less than full effective coverage due to folding of tapes in the final fabrics. However, to promote the attainment of effective coverage providing openness and air permeability for good binder curing, theoretical warp coverages less than 100% are preferred. More preferably, theoretical coverage is about 55 to about 90%, and most preferably about 60 to about 85% for a desirable combination of air permeability and stability-imparting properties.

Warp tapes of the invented backings preferably are composed of polypropylene and about 40 to about 100 mils wide and about ½ to about 5 mils thick. Tape deniers suitably range from about 300 to about 1500 g/9000 m. With tapes of these widths, average warp counts of about 10 to about 24 are effective for providing backings with suitable warp coverage. More preferably, fabrics are woven with an average of about 12 to about 20 warp tapes per inch, with the tapes having widths of about 70 to about 45 mils. Particularly preferred backings have an average of about 13 to about 18 warp tapes per inch.

Tapes suitable for weaving the invented backings are well known and have an essentially flat surface with average width to thickness ratio of at least about 15:1 and preferably from about 25:1 to about 200:1. The tapes, also sometimes referred to as ribbons and slit film yarns, preferably are composed of polypropylene resin, optionally with various additives such as pigments, process aids, heat stabilizers, antimicrobial agents and electrically conductive particles. Other thermoplastic resin compositions and formulations, such as a polyethylene or propylene-ethylene copolymers, also may be suitable. Tapes are unfibrillated and unperforated because fibrillation and perforations can reduce backing strength and stability-imparting properties. Flat or essentially smooth-surfaced tapes are generally preferred; however, contoured tapes with surface profiles such as grooves, ridges, serrations, or undulations can provide advantages for some uses. For example when the invented backings are used in carpets made by tufting through both a primary backing and the secondary backing, a contoured surface of the tapes of the secondary backing is more easily penetrated by the tufting needles. A form of tapes contoured with longitudinally disposed ridges and grooves is disclosed in commonly assigned U.S. Pat. No. 5,925,434, which is incorporated herein by reference.

Tapes can be made by any suitable means. Extrusion of thermoplastic resin composition as a melt into tapes using a suitably configured die or extrusion of film and slitting the same into individual tapes are most commonly employed. Tape thickness can be regulated by selection of the thickness of the gap in the tape or film die. In tape extrusion, width can also be controlled by adjustment of die width, while in slit film processes, spacing of the cutting means used to slit the film can be selected for desired widths. In tape extrusion, tapes are typically drawn or stretched after extrusion and cooling to increase tenacity. As a result, the finished tapes tend to be somewhat narrower and thinner than the undrawn tapes; changes in dimensions are accounted for by appropriate adjustment of die dimensions and/or spacing of cutting means, as known to persons skilled in the art. Similar considerations apply in slit film processes although adjustment of cutting means spacing will vary depending on whether drawing precedes or follows slitting.

The multifilament picks of the invented backings are present at average counts of about 12 to about 20 per inch. Taken together with warp coverage in the flat weave fabrics, the pick yarns' multifilament configuration and average count contribute to openness in the fabrics for good binder cure rates with wetability and surface for binder adhesion. Average pick counts of about 13 to about 17 are especially preferred.

The picks present in the invented backings are conventional, multifilament yarns, including spun and continuous filament yarns. Their multifilament configuration promotes wetting of the yarns by liquid binder formulations during their application in carpet finishing and, in turn, adhesion of secondary backings within the carpet structure when binders are cured. Any multifilament yarn with a relatively open, or fuzzy yarn bundle or structure for binder wetability and adhesion is suitable. Filaments of the yarns are composed of a thermoplastic resin or naturally occurring materials, such as nylons, polyethylenes, polypropylene, polyesters, olefin copolymers and cotton. Polypropylene filaments are preferred. Yarns can be textured, crimped, napped, brushed or otherwise treated to promote fuzziness and openness for wetabilty and adhesion. Preferred yarns have filaments with deniers generally ranging from about 1 to about 10. Yarn deniers suitably are about 500 to about 2800 g/9000 m, with about 1000 to about 2500 g/9000 m being preferred.

In greater detail, spun yarns suitable as picks in the backings comprise a plurality of short lengths of fiber, also referred to as staple fiber, that are twisted together to form an integral yarn structure. Staple fibers often are crimped before spinning, such as by passage through a stuffer box or over an edge, to impart a two- or three-dimensional configuration which is retained to some degree in yarns after spinning such that the yarns have greater looseness or openness and fuzziness than yarns spun from uncrimped or flat filaments. Preferred staple fibers for the yarns have about 3 to about 30 crimps per inch. Spun yarns can be made by any suitable technique, examples of which are open end spinning and ring spinning. Wrap spun yarns, in which staple fibers are spun around a continuous filament core, also are suitable. Preferred spun yarns have deniers of about 1500 to about 2400 g/9000 m and comprise polypropylene staple fibers with average lengths of about 1.5 to about 6 inches, deniers of about 3 to 8 and crimp levels of about 15 to about 25 per inch.

Continuous filament yarns for secondary carpet backings also are well known, for example from U.S. Pat. No. 4,406,310, which is incorporated herein by reference. Such yarns generally comprise about 70 to about 500 filaments per yarn, with filament deniers suitably ranging from about 3 to about 20 and yarn deniers of about 1000 to about 2000. Continuous multifilament yarns can be made by melt spinning processes well known to the fibers and yarns arts and generally comprising extruding melted thermoplastic resin from a plurality of holes in a spinneret or die, cooling the extruded filaments, gathering the filaments into a tow, stretching to increase strength and texturing such as by passage through fluid jets or other means. Continuous filament yarns preferably are twisted, capped or intermittently air entangled to promote air permeability of backings. Preferably, twist levels are about 1 to about 5 per inch and cap levels are at least about one per inch.

Warp tape and multifilament pick configurations and their average counts and warp coverage in the flat weave construction of the invented backings are such that the fabrics weigh about 1.5 to about 7 osy and have average air permeabilities, measured according to the procedure of ASTM D-737 with a pressure differential equal to 0.5 inch water, of at least about 250 ft³/min./ft². These weights are well suited to convenient handling in carpet manufacture, compatibility with a wide range of carpet styles and stability-imparting properties in finished goods, with weights of about 2 to about 6 osy being preferred. Air flow of the backings is well suited to curing of binder formulations in carpet finishing equipment operated at the high speeds for efficient carpet manufacture. Preferred backings with theoretical warp coverage of about 60 to about 85% have average air permeabilities of about 300 to about 800 ft³/min./ft², and more preferably about 350 to about 800 ft³/min./ft² and are well suited for use in modern, high speed carpet finishing ovens operating at line speeds as high as 200 ft/min.

Dimensional stability imparted by the backings in finished carpets is at least comparable, and in many cases, superior, to that imparted by conventional leno weave secondary backings. Dimensional stability-imparting properties of the invented secondary backings are indicated by stress relaxation testing of carpets made from the backings. Stress relaxation testing measures initial strain, in percent, of a sample of standard dimensions that is subjected to a stretching force when the force first reaches one hundred pounds and retained load, in lbs., required to retain the initial strain after sixteen hours at 73° F. and 50% relative humidity. The test procedure is described in detail in the examples. It is broadly applicable to carpets of different styles, constructions and weights. For purposes of comparative testing of stability-imparting properties of backings, a reference carpet is used. A suitable reference carpet is a 42 osy face weight, ⅜ inch pile height nylon tufted carpet tufted at 1/10 gauge and 10 stitches per inch as described in greater detail in the examples.

Secondary backings according to the invention, when laminated in reference carpets used for testing herein, impart dimensional stability such that initial strain in each of the warp and fill directions is no more than about 8%. Initial strain when load reaches one hundred pounds is significant because it indicates stiffness of the carpet and the amount of stretch required for good installation. Generally, the lower the sum of the initial strains in the warp and fill directions, the less likely installation will promote buckling. The sum of initial strains in the warp and fill of the tufted primary backing structures used in the reference carpets herein often are as high as 20-25%. Preferred backings according to the invention, when laminated in reference carpets impart stability such that the sum of warpwise and fillwise initial strains is no more than about 16%, and more preferably about 10 to about 15%, which is comparable to that of reference carpets made with conventional, commercially preferred leno backings.

Retained loads in both warp and fill directions of reference carpets having the invented secondary backings laminated thereto also are comparable or superior to those of reference carpets made with currently preferred commercial leno weave secondary backings. Retained loads after application of the initial one hundred pound load preferably are at least about 35 lbs. in each of the warp and fill directions, and more preferably at least about 40 lbs. Backings imparting stability such that retained loads in reference carpets are at least about 40 lbs. in both directions are beneficial due to superior resistance to buckling and damage from installation of finished carpets.

Delamination resistance-imparting properties of the invented backings are such that the backings when laminated in the reference carpets described above have peel strengths according to ASTM D-3936 of at least about 5.5 pounds/in. and preferably at least about 6 pounds/in. These levels also are comparable or superior to those of reference carpets with conventional secondary backing fabrics such as 16×5 and 18×13 leno weave backings.

Preferred fabrics according to the invention comprise warp tapes and multi-filament picks as described above in a flat weave with average warp counts of about 12 to 20 per inch and average pick counts of about 12 to about 18 picks per inch. At warp counts of 18 or greater, pick counts of about 15 or less are preferred so that the fabrics have desirable air permeabilities. Warp coverage preferably is about 60 to about 85% and pick counts most preferably are about 13 to about 17 per inch. Average air permeability of such fabrics is most preferably about 350 to about 800 ft³/min./ft². Particular constructions providing good combinations of properties are 15×15, 15×17, 16×13, 16×15, 16×17, 18×13 and 18×15.

In carpets, the invented backings impart good binder adhesion and stability, as indicated by delamination strengths, initial strains and retained loads at least comparable to those of conventional weave secondary backings with comparable warp tapes and picks in comparable counts. Carpets according to the invention generally comprise tufts of face yarn disposed on a pile side of the carpet and penetrating a primary backing structure such that a plurality of stitches of the face yarn are disposed on a stitched side opposite the pile side, with the invented secondary backing bonded to the stitched side with a binder that also surrounds or encapsulates stitches to secure them in the carpet. Generally, carpets according to the invention have retained loads 16 hours after initial strain due to a one hundred pound load of at least about 30 lbs. Peel strengths generally are at least about 3 lbs./in., and preferably at least about 4 lbs./in. Carpets according to the invention also tend to have higher seam strengths than those with leno weave secondary backings woven from comparable warp tapes and multifilament picks due to their flat construction and warp coverage.

Carpets according to the invention can be provided in the form of roll goods, as tiles or in other forms and configurations as desired. Carpet tile generally comprises a tufted primary backing structure laminated to the invented secondary backings and adhered to a substantially self-supporting substrate. Common substrates include rigid and resilient materials such as rubbers, thermoplastic elastomer formulations, vinyl plastisols and composites with glass fiber mats, fabrics or other suitable materials.

Broadloom carpets can be provided in styles, weights, tuft densities and pile heights as desired. Examples of carpet styles include Saxony, Berber, velvet, cut-and-loop, cut pile, high-low, and loop pile carpets. Cut pile styles are frequently used for residential applications while loop pile styles are more commonly used in commercial, hospitality and carpet tile applications. Carpet face weights generally range from about 10 to about 80 osy, with about 14 to about 45 osy being common for commercial carpets and about 12 to about 65 osy for residential carpets. Pile heights of about ⅜ to about ⅞ inch are common in residential carpets while about 3/16 to about ½ inch are common in commercial carpets. Tuft densities typically range from about 20 to about 300 tufts per square inch for both types of carpets. While these constructions are typical of the types of carpets currently used in various applications, persons skilled in the carpet industry will appreciate that heavier and lighter weights, longer or shorter pile heights and greater or lesser tuft densities also can be suitable for various uses.

The carpets can include any suitable primary backing structure. A wide range of primary backings is well known. They are generally flat or sheet-like, tuftable materials with flexibility and integrity suited for process manipulations and sufficient strength and tuftability for penetration by needles and face yarn during tufting while retaining strength and integrity for carpet performance. Examples include woven, knitted and nonwoven fabrics, films, sheets and composite structures having two or more such materials in combination or combinations with other materials such as scrims and netlike nonwoven fabrics. Preferred materials for backings comprise thermoplastic resins due to their desirable combination of cost and properties. Examples include polyolefins, such as polypropylene, polyethylene (low, linear low, medium or high density or so-called metallocene polyethylenes), copolymers of ethylene or propylene with each other and/or other monomers, nylons, polyesters and blends comprising such resins. Backings constructed from paper, natural materials such as jute and hemp, and other non-thermoplastic materials also can be used.

Woven polypropylene fabrics, and particularly those woven from tapes, are most commonly used for such backings owing to their superior combination of cost, tuftability, and properties such as strength, durability, mold and mildew resistance. An example is PolyBac® Fabric, which is a woven polypropylene primary backing made and sold in a range of styles by Amoco Fabrics and Fibers Company. Woven fabrics with a fibrous layer attached on one or both sides, such as by needling, fusion or a combination thereof, also are suitable; examples are disclosed in U.S. Pat. No. 4,053,668, U.S. Pat. No. 4,069,361, U.S. Pat. No. 4,123,577, and U.S. Pat. No. 4,242,394 and include commercial products such as PolyBac® FLW Fabric and Matrix Composite Primary Backing, both from Amoco.

Preferred woven primary backings are flat fabrics woven from tapes in a plain weave with weights of about 2 to about 8 osy and an average of about 10 to about 32 tapes per inch in each of the warp and fill directions. Tape dimensions generally vary from about 30 to about 125 mils wide and about 1 to about 3 mils thick; tape deniers generally range from about 300 to about 1500. Particularly preferred primary backings are plain weave fabrics woven from polypropylene tapes with averages of about 18 to about 28 warp tapes per inch and about 8 to about 18 weft tapes per inch wherein the warp tapes are about 1.3 to about 2 mils thick and about 30 to about 60 mils wide and the weft tapes are about 1.7 to about 2.3 mils thick and about 80 to about 120 mils wide. Tapes can fibrillated, unfibrillated, contoured or uncontoured. Contoured tapes can provide improved tufting performance due to easier needle penetration and, when present in backings coated with a thermoplastic resin, can facilitate tufting by preventing shifting of tapes on impingement of tufting needles.

Nonwoven primary backings are generally relatively dense mats or webs of continuous filaments or staple fibers. Nonwoven backings generally have basis weights of about 3 to about 6 osy and typically are composed of filaments having deniers of about 3 to about 20. The filaments or fibers commonly comprise polyester or polyolefin resins, such as polyethylene terephthalate and polypropylene, respectively. Polyester is generally preferred due to its greater heat stability and resistance to shrinkage, although polypropylene nonwovens also are common. An example of a polyester nonwoven backing is Lutradur® fabric. Nonwoven backings also can be calendered or needled to improve their dimensional stability, integrity and other properties. They also can be reinforced with scrims or woven fabrics, also as known. Combinations of higher and lower melting fibers in the backings can facilitate heat bonding. Although use of nonwoven primary backings in carpets is limited because the backings are often less stable against large, on-axis strains than wovens, use of nonwovens in the invented carpets can benefit from the dimensional stability-imparting effects of the invented secondary backings.

The invented carpets also can include composite primary backings, such as combinations of different woven, nonwoven or woven and nonwoven fabrics. The composites typically are formed during tufting operations by tufting face yarn through layers of the composite components brought together at or ahead of the tufter, for example as in U.S. Pat. No. 4,140,071, which discloses carpets made by tufting face yarn simultaneously through a woven polypropylene tape primary backing fabric and a bonded, lightweight nonwoven web of dyable continuous filaments.

Face yarns suitable for carpets also are well known and can be composed of any suitable material. The yarns comprise a plurality of filaments. Preferably, filaments comprise at least one thermoplastic resin; examples include nylon, such as nylon 6 and nylon 66, polyester, such as polyethylene terephthalate and polytrimethylene terephthalate, polypropylene and acrylic resins. Continuous filament yarns and spun yarns are suitable. Natural fiber yarns, such as those in which the filaments are wool or cotton also are well suited for some carpets. Combinations of yarns of different colors, weights, configurations or in other respects also can be used. Continuous filament yarns used for carpet face yarn are usually bulked to provide texture resembling natural fiber yarns. Bulking is introduced by various techniques such as texturing with fluid jets, twisting and detwisting and the like. Twisting, cabling, plying, heatsetting and combinations of such techniques are often used to impart or preserve bulk in such yarns. Such bulked continuous filament yarns are commonly referred to as “BCF” yarns. Nylon BCF yarns are most commonly used in carpets although polypropylene BCF yarns are also widely used, as are nylon spun yarns and polyester yarns. Pigmented, or so-called solution-dyed yarns, prepared by incorporating pigments into the resin from which filaments are melt spun, are suitable as are natural color yarns that are dyed after tufting, for example as part of a finishing step during carpet manufacture. Generally, BCF face yarns have linear densities of at least about 1200. Deniers up to about 10,000 are common in most conventional carpet styles although in some styles, such as Berbers, yarn deniers as high as 20,000 and even greater are known. Filament counts of typical face yarns range from about 70 to about 1200, with about 8 to about 30 denier per filament.

Binder formulations used in carpet manufacture are most commonly particulate-filled, aqueous latexes of organic polymer compositions that set or cure on heating. Heating also serves to drive off liquid components of the binders together with volatiles generated in curing reactions. Crosslinkable styrene-butadiene copolymers are most commonly used as the organic polymer of binder formulations, although polyvinyl chloride and polyurethane latexes also are well known. Calcium carbonate is most commonly used as a filler for the formulations. Filler typically is present in the latexes in significant amounts (e.g., 60-85 weight %) to impart viscosities that facilitate application of the liquid formulations. Alternatively, thermoplastic binders can be used to bind the stitches or stitches and secondary backing by melting a thermoplastic resin with lower softening or melting point than other carpet components in contact with the stitched side of a tufted backing structure and the secondary backing and then cooling to solidify the resin. Thermoplastic resins also can be applied in melted form and then cooled in contact with the stitched side and the secondary backing to solidify the resin and bind the carpet. Polypropylenes, polyethylenes (low, medium, high density; metallocene), propylene-ethylene copolymers and their blends are suitable as thermoplastic binders and can be used in various forms, such as film, fiber, fabric and powder.

The invented carpets can be prepared by any suitable means. As described previously, a primary backing structure commonly is passed through a tufting device in which a plurality of needles reciprocate to stitch the face yarns into the primary backing. Face yarn tufts can be left uncut to form loop pile carpets or they can be cut to provide a cut pile. The stitches are secured to the stitched side of the primary backing and the secondary backing is laminated to the stitched side with the binder. Liquid binder formulations such as described above typically are applied using a doctor blade or other suitable device for pressing the liquid into the structure. After application of the liquid binder formulation, the binder is cured in contact with the stitched side of the tufted primary backing and a surface of the secondary backing. Heating typically is conducted in circulating air ovens at temperatures effective to cause polymerization, chain extension and cross-linking of the binder and drive off water and other volatile components of the binder. Preferred temperatures generally range from about 300 to about 350° F. and residence times in heating are generally about 2 to about 6 minutes, with residence times up to about 4 minutes being preferred in high speed finishing lines. The invented secondary backings are well suited for use in manufacture of carpets at high cure rates and low residence times during heating.

The invention is described further in connection with the following examples, it being understood that they are for purposes of illustration but not limitation.

### EXAMPLES

### General Procedures

Air permeability of fabric samples was tested according to the procedure of ASTM D-737 with a pressure differential equal to 0.5 inch water.

Stress relaxation testing of carpet samples is a well-recognized test for dimensional stability. Initial strains and retained loads are tested at 73° F. and 50% relative humidity using a vertical mounting frame equipped with a force gauge at the top and a rotatable threaded rod and bore assembly at the bottom. Samples of carpet in the form of 2″ by 40″ strips are cut in both the warp and fill directions and the narrow ends of a sample are clamped between the force gauge and the threaded rod so that force on the sample can be increased by rotating the rod. The sample is stretched by rotating the threaded rod until the force gauge first registers 100 lbs. The strain at that point is measured and recorded as percent initial strain. The sample then is held at the initial strain for 16 hours, during which force required to retain the strain decreases. Force, in lbs., at 16 hours is measured. Carpets with higher retained load after 16 hours have better dimensional stability than those with lower retained load.

For comparative stress relaxation testing of reference carpets with different secondary backings, the reference carpet was a ⅜ inch pile height, cut pile carpet tufted at 1/10 gauge and 10 stitches per inch with 42 osy nylon face yarn using a 3.6 osy primary backing, PolyBac® Fabric Style 2261 from Amoco, with a plain weave, 24×15 construction of warp and fill polypropylene tapes, and in which the binder formulation was a commercial carboxylated styrene-butadiene latex containing 450 parts particulate calcium carbonate per 100 parts of latex solids which was applied substantially evenly to the stitched side of the tufted primary backing at about 20-22 osy and to the secondary backing at about 8-10 osy, with curing of the stitched side and the secondary backing with applied binder formulation in contact at 300 to 330° F. for 3 to 4 minutes.

Peel strength as an indication of delamination resistance was tested according to ASTM D-3936 and calculated as an average of the highest peak in each of five one-half inch intervals over three inch sample widths. Results are reported in lbs./in.

### Examples 1-8 and Controls

A series of 63-inch wide, plain weave fabrics was woven on a projectile loom using polypropylene warp tapes and spun yarn picks. The spun yarn was made by open end spinning 2.5 inch long, 4.6 denier polypropylene staple fiber that had been crimped at 20 crimps per inch; yarn deniers were 1250 to 2125 g/9000 m. Warp tapes had dimensions and deniers according to Table 1 below.

TABLE 1

| Tape | Width (mils) | Thickness (mils) | Denier (g/9000 m) |
|---|---|---|---|
| A | 65 | 1.5 | 600 |
| B | 55 | 1.8 | 600 |
| C | 48 | 1.7 | 450 |
| D | 50 | 1.8 | 475 |

Fabrics were woven from the tapes in constructions with average warp counts of 16 and 18 per inch and average pick counts of 10, 13, 15, 17 and 20 per inch. Theoretical warp coverages were calculated as the product of warp count and tape width and air permeabilities were measured.

Fabric constructions and weights, pick yarn deniers, theoretical warp coverages and air permeabilities are reported in Table 2. Tapes used in the fabric samples are indicated by their designations according to Table 1 in the Count/Tape column of Table 2; for example, referring to Fabric Sample A, it can be seen from the Count/Tape column that the warp tapes A were used in a construction with average warp and pick counts of 16 and 13 per inch, respectively. Fabrics Samples according to the invention are designated as Examples 1-8. For comparison, samples of commercially available secondary backings woven from warp tapes and spun yarn picks were also tested for air flow. The commercial backing samples were ActionBac® Fabric style 3808, an 18×13 leno weave backing; ActionBac® Fabric style 3870, a 16×5 leno weave backing; and a discontinued 24×15 plain weave backing style. These are designated 3808, 3870 and XX in Table 2. Also for comparison, a needled, 24×15 plain weave fabric with warp and pick tapes according to the teachings of U.S. Pat. No. 3,542,632 was tested. It is designated YY in the Table.

TABLE 2

| | Count/Tape | Warp | | | Air Flow |
|---|---|---|---|---|---|
| Fabric | Warp × | Coverage | Pick | Weight | (ft³/min./ |
| Sample | Pick | (%) | Denier | (osy) | ft²) |
| A | 16A × 13 | 105 | 1440 | 3.6 | 86 |
| B | 16A × 15 | 105 | 1440 | 3.9 | 58 |
| C | 16A × 17 | 105 | 1440 | 4.4 | 41 |
| Example 1 | 18B × 13 | 99 | 1440 | 3.8 | 318 |
| Example 2 | 18B × 15 | 99 | 1440 | 4.1 | 290 |
| D | 18B × 17 | 99 | 1440 | 4.4 | 236 |
| Example 3 | 18B × 13 | 99 | 1260 | 3.7 | 329 |
| Example 4 | 18B × 15 | 99 | 1260 | 4.0 | 246 |
| E | 18B × 17 | 99 | 1260 | 4.4 | 215 |
| Example 5 | 16C × 13 | 77 | 1260 | 3.3 | 506 |
| Example 6 | 16C × 15 | 77 | 1260 | 3.7 | 436 |
| Example 7 | 16C × 17 | 77 | 1260 | 4.1 | 356 |
| F | 16C × 10 | 77 | 1260 | 2.7 | 388 |
| G | 16C × 10 | 77 | 2126 | 4.3 | 337 |
| H | 16C × 13 | 77 | 2126 | 5.2 | 224 |
| Example 8 | 16C × 15 | 77 | 2126 | 5.9 | 326 |
| I | 16C × 17 | 77 | 2126 | 6.5 | 163 |
| J | 16C × 20 | 77 | 2126 | 7.5 | 118 |

Commercial Secondary Backing Samples

| | | | | | |
|---|---|---|---|---|---|
| 3808 | 18C × 13 | <40 | 1714 | 4.2 | 728 |
| 3870 | 16C × 5 | <40 | 1714 | 2.1 | >760 |
| XX | 24D × 15 | 120 | 1714 | 5.1 | 82 |

Needled Woven Tape Backing According to U.S. Pat. No. 3,542,632

| | | | | | |
|---|---|---|---|---|---|
| YY | 24D × 15 | 120 | 1050 | 3.5 | 23 |

As seen from Table 2, all of the Fabric Samples with warp tapes A had theoretical warp coverages above 100% and air permeabilities below 100 ft³/min./ft². Those permeabilities are not suited to efficient binder cure rates in modern, high speed carpet finishing lines. A slight decrease in theoretical warp coverage of the fabrics with warp tapes B provided air permeabilities of about 250 ft³/min./ft² or greater in Examples 1-4. Still greater air flows were achieved in the lower theoretical warp coverage fabrics with warp tapes C at pick counts of 13, 15 and 17. The 16×10 constructions of Fabric Samples F and G had good air permeabilities but both were “sleazy” and skewed easily, indicating unsuitability as secondary backings. Also as seen in the table, air permeabilities of the commercial leno weave backings were high, but those of plain weave backings XX and YY were very low.

### Controls K-N

Another series of fabrics was prepared as described above from warp tapes C and 1650 denier polypropylene continuous multifilament yarns capped every 1-1½ inch. Fabric constructions, theoretical warp coverages, weights and air permeabilities are reported in Table 3.

TABLE 3

| | | Warp | | Air Flow |
|---|---|---|---|---|
| | Count/Tapes | Coverage | Weight | (ft³/min./ |
| Sample | Warp × Pick | (%) | (osy) | ft²) |
| K | 16 × 10 | 77 | 3.4 | 427 |
| L | 16 × 13 | 77 | 4.0 | 207 |
| M | 16 × 15 | 77 | 4.6 | 188 |
| N | 16 × 17 | 77 | 5.1 | 121 |

As seen from Table 3, only the 16×10 fabric with continuous filament yarn had air permeability greater than 250 (ft³/min./ft²); however, lower denier, twisted or more highly capped continuous filament yarns provide acceptable air flows in constructions according to the invention. The 16×10 sample, K, skewed easily.

### Examples 9-12 and Control

Another series of fabrics was woven from warp tapes C and spun yarns as used in Examples 1-8 and Controls in a two-by-two half-basket weave. Fabric details and air permeabilities are reported in Table 4.

TABLE 4

| | Counts | Warp | | | Air Flow |
|---|---|---|---|---|---|
| Fabric | Warp × | Coverage | Pick | Weight | (ft³/min./ |
| Sample | Pick | (%) | Denier | (osy) | ft²) |
| O | 16 × 10 | 77 | 1260 | 2.9 | >760 |
| Example 9 | 16 × 13 | 77 | 1260 | 3.4 | 656 |
| Example 10 | 16 × 15 | 77 | 1260 | 3.8 | 554 |
| Example 11 | 16 × 17 | 77 | 1260 | 4.1 | 611 |
| Example 12 | 16 × 20 | 77 | 1260 | 4.6 | 435 |

As seen from Table 4, the half-basket weave fabric constructions provided high air permeabilities at pick counts from 10 to 20; however, as with the 16×10 flat fabrics of the other examples, Sample O was sleazy and skewed badly, indicating lack of strength and integrity of weave for use as a secondary carpet backing.

### Examples 13-14

Another series of fabrics was woven from warp tapes C and the 1260 denier spun yarn picks used in Examples 1-8 and Controls in a left-hand twill weave construction. Fabric details and permeabilities are reported in Table 5.

TABLE 5

| | | Warp | | |
|---|---|---|---|---|
| Fabric | Count/Tapes | Coverage | Weight | Air Flow |
| Sample | Warp × Pick | (%) | (osy) | (ft³/min./ft²) |
| Example 13 | 16 × 17 | 77 | 4.1 | 280 |
| Example 14 | 16 × 20 | 77 | 4.6 | 277 |

### Example 15 and Controls

Carpet samples were made in back to back runs on a commercial carpet finishing line by laminating a 42 osy nylon cut pile tufted primary backing with ⅜ inch pile height, 1/10 gauge, and 10 stitches per inch to secondary backing samples using an aqueous styrene-butadiene latex binder containing 450 parts of calcium carbonate filler per 100 parts of latex solids. Lamination was carried out at a line speed of about 30 ft/min. in a 100 foot long forced air oven at an internal air temperature of 300 to 330° F. The secondary backing used in Example 15 was that prepared in Example 6 above. Controls also were prepared from ActionBac® Fabric style 3865, a commercial leno weave secondary backing that is a different colored version of style 3870 described above in connection with Examples 1-8 and in Table 2, and ActionBac® Fabric style 3808, which is designated Fabric Sample 3808 in Table 2.

Carpet samples were tested for stress relaxation and peel strength. Binder and total weights of the finished carpets are also reported in the table. Binder weights were determined based on the known filler load of the liquid binder formulation that was used, face yarn and backing weights, and ash content measured by burning samples. The small sample dimensions are believed to be responsible for differences in carpet and binder weights.

Details of carpet constructions, weights and test results appear in Table 6.

TABLE 6

| | | | | | Stress | |
|---|---|---|---|---|---|---|
| | | | | | Relaxation | |
| | | | | Peel | Warp/Fill | |
| | Secon- | | | Test | Initial | Retained |
| | dary | Weight (osy) | | (lbs/ | Strain | Load |
| Sample | Backing | Carpet | Binder | in.) | (%) | (lbs.) |
| Example 15 | Example 6 | 68.5 | 29.4 | 7.8 | 6.3/5.4 | 42.5/40 |
| P | 3865 | 64.6 | 30.6 | 6.0 | 6.1/7.7 | 42.5/40 |
| Q | 3808 | 69.7 | 33.0 | 5.5 | 5.6/6.8 | 40/40 |

As seen from these examples and the table, the carpet of Example 15, with the fabric of Example 6 as a secondary backing, had higher peel strength than the controls and retained loads equivalent to the carpet with the commercial 5-pick leno weave secondary backing and slightly better in the warp direction than that with the commercial 13-pick leno secondary backing.

### Example 16 and Controls

Carpet samples were made in back-to-back runs on a commercial carpet finishing line by laminating a nylon high/low loop pile-tufted woven polypropylene primary backing (5000 denier 2-ply cabled bulked continuous filament nylon face yarn tufted at 27 osy face weight, 5/32 gauge and 7.5 stitches per inch) to secondary backing samples using an aqueous styrene-butadiene latex binder containing 450 parts of calcium carbonate filler per 100 parts latex solids. Lamination was carried out at a line speed of about 30 ft/min. in a 100 foot long forced air oven at an internal air temperature of 300 to 330° F. The secondary backing used in Example 16 was that from Example 6. Controls were made using a commercial 16×5 leno weave secondary backing (ActionBac® Fabric style 3865), the plain weave fabric designated XX in Table 2, the needled plain weave fabric designated YY in Table 2, and a commercial leno weave secondary backing, designated ZZ, similar to Fabric Sample 3808 according to Table 2 but with an 18×15 construction of warp tapes and spun yarn picks.

TABLE 7

| | | | | Stress Relaxation | |
|---|---|---|---|---|---|
| | | Carpet | Peel | (Warp/Fill) | |
| | | Total | Test | | Retained |
| | Secondary | Weight | (lbs./ | Initial | Load |
| Sample | Backing | (osy) | in.) | Strain (%) | (lbs.) |
| Example 16 | Example 6 | 75.7 | 5.4 | 5.9/5.0 | 31.2/35.0 |
| R | 3865 | 73.0 | 3.7 | 6.3/6.7 | 30.0/32.5 |
| S | XX | 77.6 | 3.5 | 6.2/4.0 | 30.5/32.5 |
| T | YY | 74.0 | 0.9 | 6.4/4.0 | 35.0/37.5 |
| U | ZZ | 75.6 | 4.3 | 6.4/6.8 | 30.0/27.5 |

### Examples 17-18

Carpets were made by the procedure of Example 16 except that a cut pile tufted primary backing with nylon face yarn tufted at 53 osy face weight, 1/10 gauge and 13.5 stitches/inch was used. In Example 17, the secondary backing was that made in Example 6. The finished carpet weighed 88.2 osy and peel strength of the secondary backing was 7.2 lbs/inch. In Example 18, the secondary backing was that made in Example 7. The finished carpet weighed 90.2 osy and peel strength was 7.8 lbs/inch.

We claim:

1. A carpet backing comprising a woven fabric having a flat weave construction with an average of about 12 to about 24 warp tapes per inch providing 50 to about 100% theoretical warp coverage but less than full effective warp coverage and with an average of about 12 to about 20 multifilament picks per inch, such that the fabric has a weight of about 1.5 to about 7 osy and average air permeability of at least about 250 ft³/min./ft.², determined according to ASTM D-737 with a pressure differential equal to 0.5 inch water

2. The carpet backing of claim 1 wherein the warp tapes comprise polypropylene and have widths of about 40 to about 100 mils.

3. The carpet backing of claim 2 wherein the picks have deniers of about 1000 to about 2500 g/9000 m.

4. The carpet backing of claim 3 wherein the average pick count is about 13 to about 18 per inch.

5. The carpet backing of claim 1 wherein theoretical warp coverage is about 55 to about 90%.

6. The carpet backing of claim 5 wherein the average warp count is about 13 to about 18 per inch and the average pick count is about 13 to about 17 per inch.

7. The carpet backing of claim 6 wherein the multi-filament picks are spun yarns.

8. The carpet backing of claim 1 wherein the flat weave construction is a plain weave.

9. A carpet comprising a primary backing structure having a plurality of tufts comprising face yarn extending therefrom on a pile side and a plurality of stitches comprising face yarn disposed on a stitched side opposite the pile side, and a secondary backing laminated to the stitched side with a cured binder, wherein the secondary backing comprises a woven fabric having a flat weave construction with an average of about 12 to about 24 warp tapes per inch providing 50 to about 100% theoretical warp coverage but less than full effective warp coverage and with an average of about 12 to about 20 multifilament picks per inch, such that the fabric has a weight of about 1.5 to about 7 osy and average air permeability of at least about 250 ft³/min./ft.² determined according to ASTM D-737 with a pressure differential equal to 0.5 inch water.

10. The carpet of claim 9 wherein the warp tapes of the secondary backing comprise polypropylene and the tapes are about 40 to about 100 mils wide.

11. The carpet of claim 10 wherein the picks comprise polypropylene filaments and have deniers of about 1000 to about 2500 g/9000 m.

12. The carpet of claim 11 wherein the secondary backing has an average pick count of about 13 to about 17 per inch and an average warp count of about 12 to about 20 tapes per inch, provided that when the average warp count is 18 per inch or greater, the average pick count is about 15 per inch or fewer.

13. The carpet of claim 12 wherein the secondary backing has a plain weave construction.

14. The carpet of claim 9 having warpwise and fillwise retained load of at least 30 lbs. at constant strain and 73° F. and 50% relative humidity 16 hours after initial strain due to application of a one hundred pound load.

15. The carpet of claim 9 wherein the primary backing comprises a woven polypropylene backing.

16. In a process for making a carpet comprising steps comprising tufting a primary backing structure with at least one face yarn to form a plurality of tufts on a pile side of the primary backing structure and a plurality of stitches on a stitched side opposite the pile side, contacting the stitched side and a secondary backing with a binder and curing the binder in contact with the stitched side and the secondary backing to laminate the secondary backing to the stitched side, the improvement wherein the secondary backing is a carpet backing according to claim 1.

17. The process of claim 16 wherein curing of the binder in contact with the stitched side and the secondary backing comprises heating at about 300 to about 350° F. for about 2 to about 6 minutes.

18. The process of claim 16 wherein the primary backing comprises a woven polypropylene backing.

19. The process of claim 18 wherein the secondary backing has an average warp count of about 12 to about 18 and an average pick count of about 13 to about 16.

20. The process of claim 16 wherein the secondary backing has average air permeability of about 300 to about 800 ft³/min./ft.².
